(19) United States
(12) Patent Application Publication
(10) Pub. No.: US 2015/0302081 A1
(43) Pub. Date: Oct. 22, 2015

(54) MERGING OBJECT CLUSTERS

(71) Applicant: CANON KABUSHIKI KAISHA, Tokyo (JP)

(72) Inventor: BRADLEY SCOTT DENNEY, Irvine, CA (US)

(73) Assignee: CANON KABUSHIKI KAISHA, Tokyo (JP)

(21) Appl. No.: 14/255,649

(22) Filed: Apr. 17, 2014

(51) Int. Cl. G06F 17/30

(52) U.S. Cl. CPC G06F 17/30601

(57) ABSTRACT

A determination is made as to whether to merge clusters of objects. Semantic information is input for at least one of the objects. A compactness of a candidate cluster to be formed when a first cluster and a second cluster are merged is evaluated. A cluster quality of the candidate cluster is evaluated, based on the semantic information. The first cluster and the second cluster are merged in a case that the compactness of the candidate cluster relative to a compactness of the first and second clusters exceeds a compactness threshold, and the cluster quality of the candidate cluster relative to a cluster quality of the first and second clusters exceeds a cluster quality threshold.

### FIELD OF THE INVENTION

The present disclosure relates to merging clusters of related objects (such as images), and more specifically to application of cluster merging criteria.

### BACKGROUND OF THE INVENTION

In the field of data analysis and retrieval, it is common to perform clustering to help describe features of multiple objects in a generalized manner. In particular, objects that are similar are grouped in clusters so that objects may be represented in a more compact way. For example, in the context of images, a cluster may be referred to as a “visual word” because it represents a general visual concept. A series of visual words may be used to construct a “visual vocabulary” for describing or comparing images.

In one example, clustering is performed by “K-means” clustering. K-means clustering aims to partition n objects into k clusters based on respective data points corresponding to one or more objects. Specifically, in K-means clustering for images, each data point corresponding to an image feature is assigned to a cluster with the nearest centroid (arithmetic mean of all points in the cluster). When all points have been assigned, the positions of the centroids are recalculated. The assigning of points and recalculation of centroids are iterated until the centroids no longer move.

### SUMMARY

Nevertheless, K-means clustering and other conventional clustering methods often result in cluster sets which are impractical or undesirable. For example, with images, the number of clusters generated by conventional means may not be suitable for a visual vocabulary. If too few clusters are generated, the visual vocabulary is not descriptive enough. If too many clusters are generated, the visual words are very small and cover an overly specific set of visual features. Similar shortcomings may occur when describing other types of objects (e.g., audio files).

The foregoing situation is addressed by determining whether to merge clusters of objects based on both a cluster compactness measure and a cluster quality measure.

Thus, in an example embodiment described herein, a determination is made as to whether to merge clusters of objects. Semantic information is input for at least one of the objects. A compactness of a candidate cluster to be formed when a first cluster and a second cluster are merged is evaluated. A cluster quality of the candidate cluster is evaluated, based on the semantic information. The first cluster and the second cluster are merged in a case that the compactness of the candidate cluster relative to a compactness of the first and second clusters exceeds a compactness threshold, and the cluster quality of the candidate cluster relative to a cluster quality of the first and second clusters exceeds a cluster quality threshold.

By determining whether to merge clusters of objects based on both a cluster compactness measure and a cluster quality measure, it is ordinarily possible to create a vocabulary with an appropriate number of clusters. For example, when clustering images, it is ordinarily possible to create a visual vocabulary which generalizes when necessary (e.g. when there is insufficient data to be more specific or too much noise or variation to be more specific), but also has a sufficient number of visual words to describe different visual features.

In one example aspect, the compactness threshold is based on a number of objects in the first cluster, the number of objects overall, and the number of dimensions of the objects.

In other example aspects, the semantic information describes one or more semantic labels of the image. In another example aspect, at least two or more semantic informations of one or more objects in the first cluster and the second cluster are related.

In still another example aspect, cluster compactness is evaluated based at least on an average standard deviation in all dimensions of one or more object features in a cluster.

In yet another example aspect, cluster compactness is evaluated based at least on a standard deviation in a direction of a line connecting the center of the first cluster and the center of the second cluster in a vector space defined by the first cluster and the second cluster.

In other example aspects, the cluster quality is based on a Rand Index, a Relational Rand Index, or a Mutual Information measure, and the cluster quality threshold is based on an expected Rand Index, an expected Relational Rand Index, or an expected Mutual Information measure. Some of these concepts are known, whereas others are defined herein.

In still another example aspect, an existing cluster of objects is split into a plurality of clusters. Semantic information is input of at least one of the objects in the existing cluster. A respective compactness is evaluated of each of a first candidate cluster and a second candidate cluster to be formed when the existing cluster is split. A respective cluster quality of each of the first candidate cluster and the second candidate cluster is evaluated based on the semantic information. The existing cluster is split in a case that the respective compactness of the first candidate cluster and the second candidate cluster relative to the compactness of the existing cluster each exceed a compactness threshold, and the respective cluster quality of the first candidate cluster and the second candidate cluster relative to a cluster quality of the existing cluster exceed a cluster quality threshold.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of computing equipment relevant to one example embodiment.

FIG. 2 is a detailed block diagram depicting the internal architecture of the host computer shown in FIG. 1 according to an example embodiment.

FIG. 3 is a representational view of a cluster merging module according to an example embodiment.

FIGS. 4A and 4B are flow diagrams for explaining merging of clusters according to an example embodiment.

FIGS. 5A to 5C are views for explaining evaluation of compactness of clusters according to an example embodiment.

FIGS. 6A to 6D are views for explaining sample clusters to be evaluated for compactness according to example embodiments.

FIGS. 7A to 7B are views for explaining sample clusters to be evaluated for compactness according to example embodiments.

FIG. 7C is a view for explaining evaluation of compactness of clusters according to an example embodiment.

FIGS. 8A to 8C are views for explaining a process of merging clusters according to an example embodiment.

FIG. 9A to 9C are views for explaining evaluation of a merger of clusters according to an example embodiment.

### DETAILED DESCRIPTION

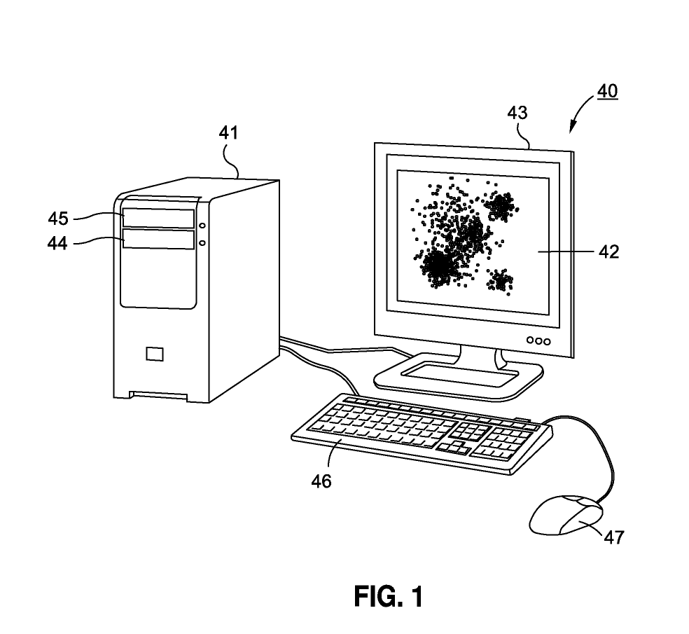

FIG. 1 is a representative view of computing equipment relevant to one example embodiment. Computing equipment 40 includes host computer 41 which generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Computing equipment 40 includes color monitor 43 including display screen 42, keyboard 46 for entering text data and user commands, and pointing device 47. Pointing device 47 preferably comprises a mouse for pointing and for manipulating objects displayed on display screen 42.

Host computer 41 also includes computer-readable memory media such as computer hard disk 45 and DVD disk drive 44, which are constructed to store computer-readable information such as computer-executable process steps. DVD disk drive 44 provides a means whereby host computer 41 can access information, such as image data, computer-executable process steps, application programs, etc. stored on removable memory media. Other devices for accessing information stored on removable or remote media may also be provided.

Host computer 41 may acquire digital image data from other sources such as a digital video camera, a local area network or the Internet via a network interface. Likewise, host computer 41 may interface with other color output devices, such as color output devices accessible over a network interface.

Display screen 42 displays a clustering of data. In that regard, while the below processes will generally be described with respect to images for purposes of conciseness, it should be understood that other embodiments could also operate on other objects. For example, other embodiments could be directed to clustering omic data, audio files or moving image files. In that regard, as described herein, “object” refers to the data being clustered (e.g., images, audio files, omic files, or moving image files). At least one of the objects is described using semantic information. Meanwhile, “feature” refers to features of the objects, which can be examined to determine whether to merge the clusters of objects, as described below. “Object feature” may also be used herein to describe the features of the objects.

In addition, while FIG. 1 depicts host computer 41 as a personal computer, computing equipment for practicing aspects of the present disclosure can be implemented in a variety of embodiments, including, for example, a digital camera, mobile devices such as cell phones, ultra-mobile computers, netbooks, portable media players or game consoles, among many others. In addition, embodiments of the disclosure might combine one or more computing elements. For example, the computer might be connected to or combined with a scanner or multifunction printer (MFP) which scans or inputs image, in order to retrieve or identify a corresponding image or identify related content on another device. In another example, a cloud service according to the disclosure might use several computers to organize and sort images using the cluster merging procedures described herein.

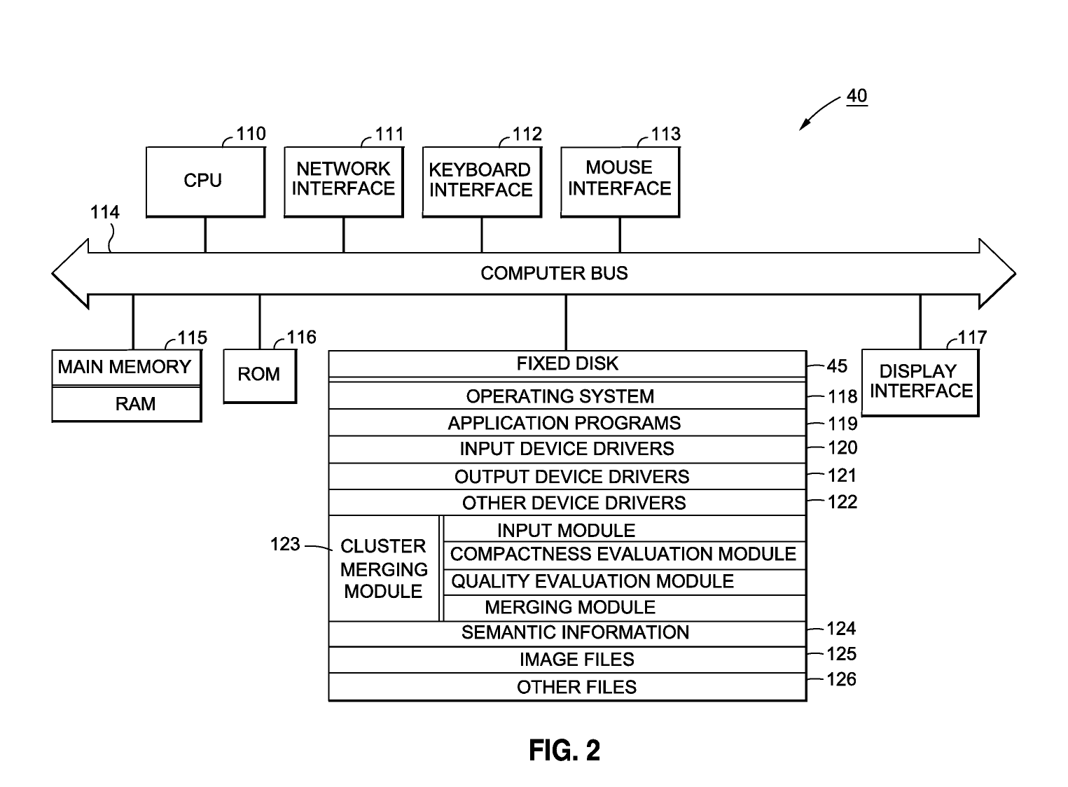

FIG. 2 is a detailed block diagram showing the internal architecture of host computer 41 of computing equipment 40. As shown in FIG. 2, host computer 41 includes central processing unit (CPU) 110 which interfaces with computer bus 114. Also interfacing with computer bus 114 are hard disk 45, network interface 111, random access memory (RAM) 115 for use as a main run-time transient memory, read only memory (ROM) 116, display interface 117 for monitor 43, keyboard interface 112 for keyboard 46, and mouse interface 113 for pointing device 47.

RAM 115 interfaces with computer bus 114 so as to provide information stored in RAM 115 to CPU 110 during execution of the instructions in software programs such as an operating system, application programs, cluster merging modules, and device drivers. More specifically, CPU 110 first loads computer-executable process steps from fixed disk 45, or another storage device into a region of RAM 115. CPU 110 can then execute the stored process steps from RAM 115 in order to execute the loaded computer-executable process steps. Data such as color images or other information can be stored in RAM 115, so that the data can be accessed by CPU 110 during the execution of computer-executable software programs, to the extent that such software programs have a need to access and/or modify the data.

As also shown in FIG. 2, hard disk 45 contains computer-executable process steps for operating system 118, and application programs 119, such as graphic image management programs. Hard disk 45 also contains computer-executable process steps for device drivers for software interface to devices, such as input device drivers 120, output device drivers 121, and other device drivers 122. Semantic information 124 includes information such as semantic labels describing image files, audio files or other data. Image files 125, including color image files, and other files 126 are available for output to output devices and for manipulation by application programs.

Cluster merging module 123 comprises computer-executable process steps, and generally comprises an input module, a compactness evaluation module, a quality evaluation module, and a merging module. Cluster merging module 123 inputs clusters of images (or other data), and outputs a determination of whether or not to merge the image clusters, along with, in some cases, the merged clusters. More specifically, cluster merging module 123 comprises computer-executable process steps executed by a computer for causing the computer to perform a method for determining whether to merge clusters of objects, as described more fully below.

The computer-executable process steps for cluster merging module 123 may be configured as a part of operating system 118, as part of an output device driver such as a printer driver, or as a stand-alone application program such as an image management system. They may also be configured as a plug-in or dynamic link library (DLL) to the operating system, device driver or application program. For example, cluster merging module 123 according to example embodiments may be incorporated in an input/output device such as a camera with a display, in a mobile output device (with or without an input camera) such as a cell-phone or music player, or provided in a stand-alone image management application for use on a general purpose computer. It can be appreciated that the present disclosure is not limited to these embodiments and that the disclosed cluster merging module 123 may be used in other environments in which image clustering is used.

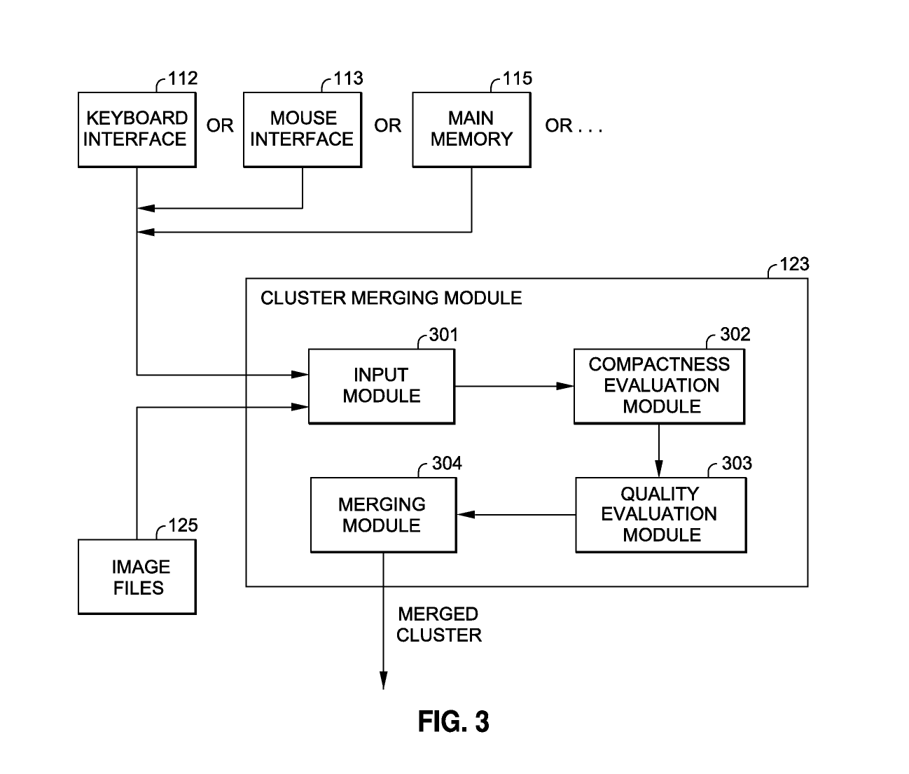

FIG. 3 illustrates the cluster merging module of FIG. 2 according to an example embodiment.

In particular, FIG. 3 illustrates example architecture of cluster merging module 123 in which the sub-modules of cluster merging module 123 are included in fixed disk 45. Each of the sub-modules are computer-executable software code or process steps executable by a processor, such as CPU 110, and are stored on a computer-readable storage medium, such as fixed disk 45 or RAM 115. More or less modules may be used, and other architectures are possible.

As shown in FIG. 3, cluster merging module 123 includes an input module 301 for inputting clusters of objects and semantic information of at least one of the objects, a compactness evaluation module 302 for evaluating a compactness of a candidate cluster to be formed when a first cluster and a second cluster are merged, and a quality evaluation module 303 for evaluating a cluster quality of the candidate cluster based on the semantic information. Merging module 304 merges the first cluster and the second cluster in a case that the compactness of the candidate cluster relative to a compactness of the first and second clusters exceeds a compactness threshold, and the cluster quality of the candidate cluster relative to a cluster quality of the first and second clusters exceeds a cluster quality threshold. Each of these functions will be described more fully below.

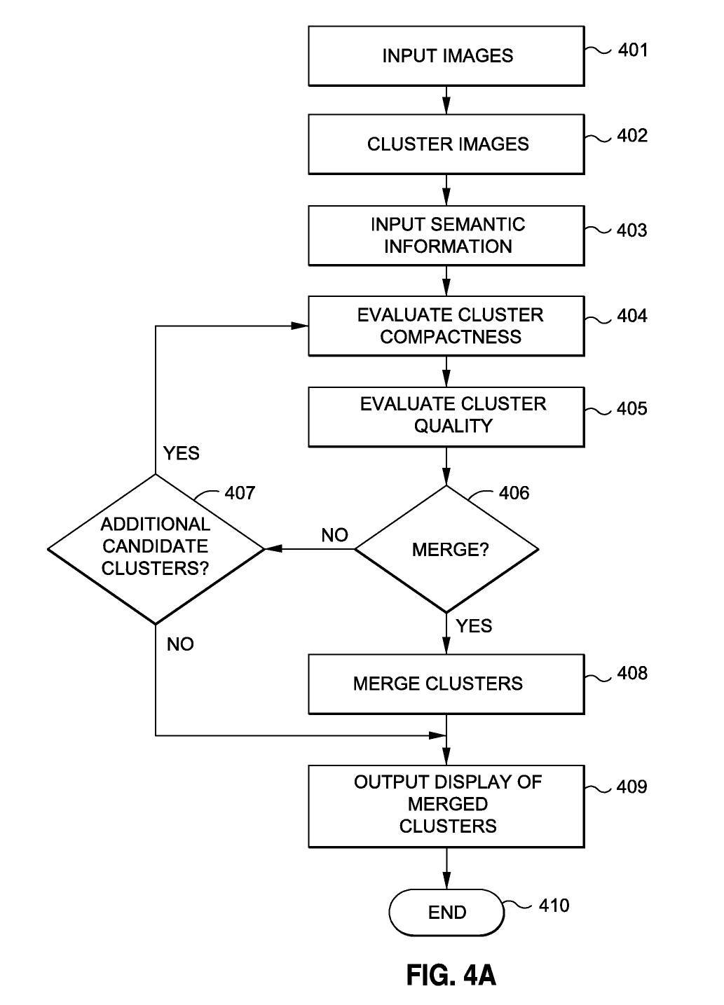

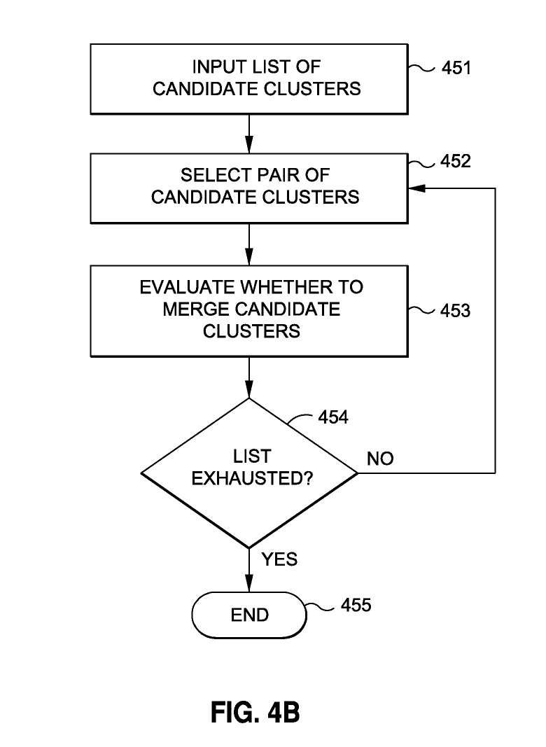

FIG. 4 is a flow diagram for explaining the determination of whether or not to merge clusters of objects according to an example embodiment. As mentioned above, while the below processes will generally be described with respect to images for purposes of conciseness, it should be understood that other embodiments could also operate on other objects. For example, other embodiments could be directed to omic data, audio files, or moving image files.

Briefly, in FIG. 4, a determination is made as to whether to merge clusters of objects. Semantic information is input for at least one of the objects. A compactness of a candidate cluster to be formed when a first cluster and a second cluster are merged is evaluated. A cluster quality of the candidate cluster is evaluated, based on the semantic information. The first cluster and the second cluster are merged in a case that the compactness of the candidate cluster relative to a compactness of the first and second clusters exceeds a compactness threshold, and the cluster quality of the candidate cluster relative to a cluster quality of the first and second clusters exceeds a cluster quality threshold.

In more detail, in step 401, images or other data to be clustered are input. The images may, for example, be previously stored (e.g., as image files 125 on fixed disk 45), or may be acquired from another device over a network or local connection. Numerous other methods for inputting images or other data may be used, but for purposes of conciseness will not be described here in detail.

In step 402, the input images are clustered. The clustering may be performed according to known methods, such as K-means clustering of features derived from the images.

In step 403, semantic information is input for at least one of the images. In particular, at least one of the images will have a semantic label or “ground truth” by which the image has been previously categorized. For example, an image object including a set of features which in some manner depict or describe a dog may be labeled “dog”, and this semantic label is input for use in determining whether to merge any clusters, as described below with respect to step 405. Thus, in some embodiments, the semantic information describes one or more semantic labels of an image.

In step 404, there is an evaluation of the compactness of a candidate cluster to be formed when a first and second cluster are merged. Put another way, there is a determination of whether the candidate merged cluster extent will be “small enough”. In the following analysis, the statistics of the sub-clusters (i.e., the first and second clusters) and the entire cluster (i.e., the candidate merged cluster) are examined.

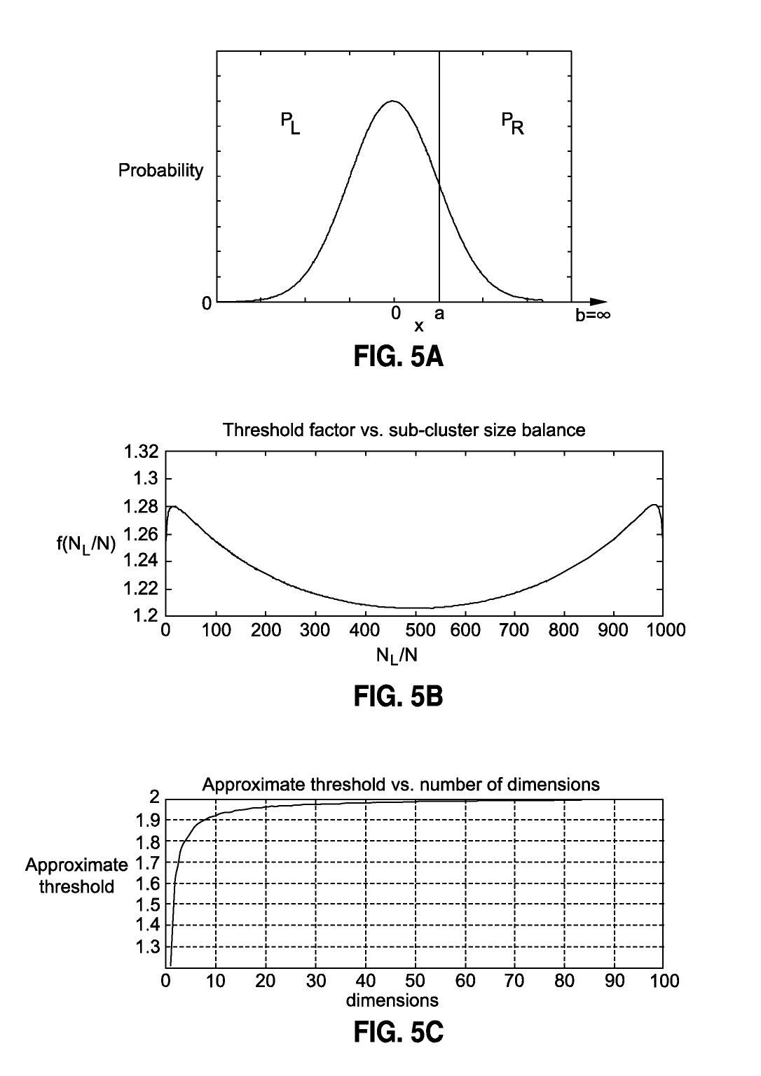

Examples of evaluating compactness of a candidate cluster will now be described with respect to FIG. 5A to FIG. 7C.

Suppose a cluster is formed from a multivariate (d dimensional) Gaussian distribution with a diagonal covariance matrix with all diagonal elements equal to σ². A hyper-plane can be considered which partitions samples generated from this distribution into two sub-clusters. A hyper-plane is a plane in multiple dimensions, e.g., a dividing line or plane between data points in multiple dimensions, and has all the characteristics of a plane. Since the multivariate Gaussian distribution is symmetric, it can be considered that all separating hyper-planes that are a fixed distance (as measured by a normal line to the plane) from the cluster mean are equivalent. Put another way, splits of symmetric multivariate Gaussians by a hyper-plane can be considered as 1-dimensional splits in the direction of a line from the mean and orthogonal to the splitting hyper-plane, whereas the remaining dimensions orthogonal to this dimension are left unchanged. In other words, this is equivalent to considering the split of the multivariate Gaussian distribution in just one dimension, while the other dimensions are left as is.

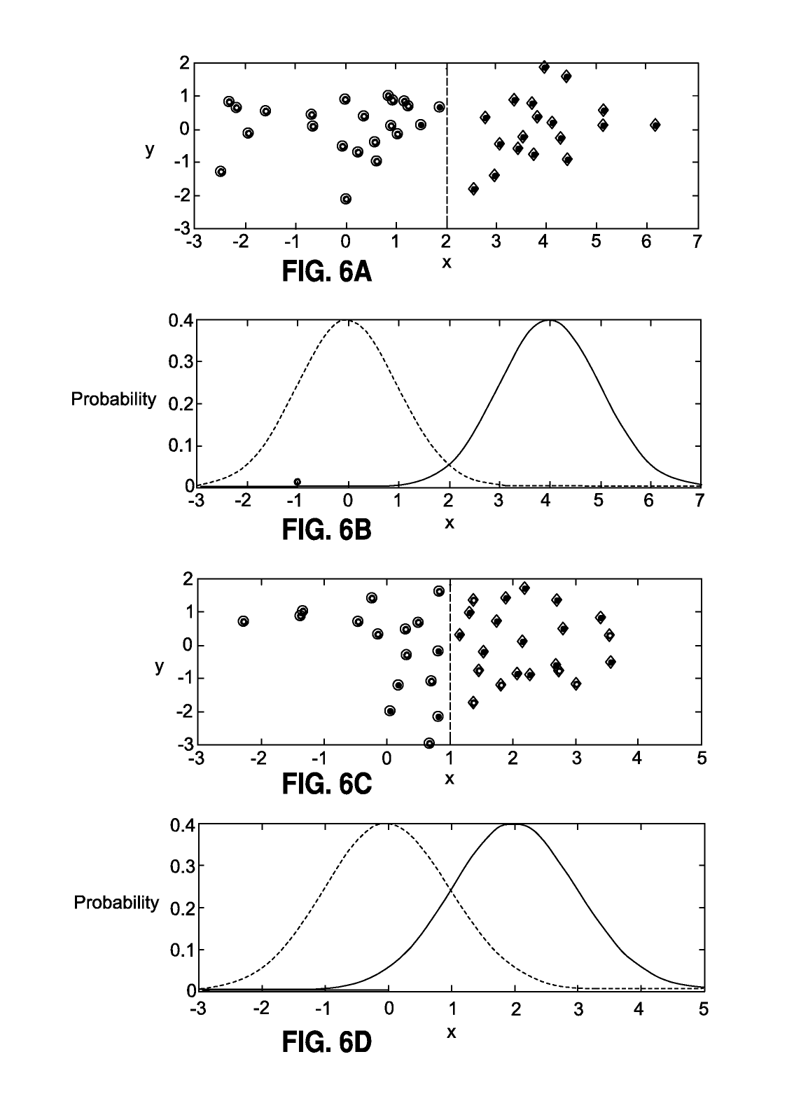

In that regard, FIG. 5A depicts such a Gaussian distribution, split at a distance “a” from the mean of the distribution into regions L and R. For purposes of simplicity, the description below generally addresses two clusters such as those shown in FIG. 6A or 6C. Statistics of those two clusters are examined to determine whether they should be merged into a single cluster, with the desired effect of the merged cluster approaching the Gaussian distribution shown in FIG. 5A.

In one embodiment, cluster compactness is evaluated based at least on a standard deviation in a direction of a line connecting the center of the first cluster and the center of the second cluster in a vector space defined by the first cluster and the second cluster.

If the Gaussian distribution in FIG. 5A is partitioned into two regions R and L, and the two regions are considered as truncated Gaussian distributions, the mean of the right region (the mean μ of region R) can be described as follows:

$${μ}_{R} = [ \frac{φ ( \frac{a}{σ} )}{1 - Φ ( \frac{a}{σ} )} ] σ \qquad ( 1 )$$

In the above equation,

$$Φ ( x ) = \frac{1}{\sqrt{2 π}} {e}^{- {x}^{2} / 2} , Φ ( x ) = {\int }_{- ∞}^{x} φ ( t ) d t , \qquad$$

σ is the standard deviation of the original Gaussian distribution before the split, and a is the dividing point/line/hyper-plane. Meanwhile, the variance of the right region (how “spread out” the feature points are) is given by

$${σ}_{R}^{2} = [ 1 + \frac{\frac{a}{σ} φ ( \frac{a}{σ} )}{1 - Φ ( \frac{a}{σ} )} - {( \frac{φ ( \frac{a}{σ} )}{1 - Φ ( \frac{a}{b} )} )}^{2} ] {σ}^{2} \qquad ( 2 )$$

If the total distribution generates N samples, then the number of samples expected to be in R to be

$${N}_{R} \approx N [ 1 - Φ ( \frac{a}{σ} ) ]$$

so as an estimate of the normalized partition value

$$x = \frac{a}{σ} = {Φ}^{- 1} ( \frac{N - {N}_{R}}{N} ) = {Φ}^{- 1} ( \frac{{N}_{L}}{N} ) .$$

The above analysis can be repeated for the variance of L:

$${σ}_{L}^{2} = [ 1 - \frac{\frac{a}{σ} φ ( \frac{a}{σ} )}{Φ ( \frac{a}{σ} )} - {( \frac{φ ( \frac{a}{σ} )}{Φ ( \frac{a}{b} )} )}^{2} ] {σ}^{2} \qquad ( 3 )$$

When the two clusters L and R are merged, the extent of the clusters is only increased in the direction orthogonal to the separating hyper-plane. If the L and R clusters are drawn from a single multivariate Gaussian distribution, the new standard deviation in the merged direction is simply σ. If the L and R clusters are generated from separated distinct Gaussians, then the extent of the merger in that direction is closer to σ_{L}+σ_{R}, and can even be greater than this when the clusters are far apart.

Thus, in the case when the data is generated from a single Gaussian distribution, adding the width of R and L gives

$${σ}_{L} + {σ}_{R} = \{ {[ 1 + \frac{Nx φ ( x )}{{N}_{R}} - {( \frac{N φ ( x )}{{N}_{R}} )}^{2} ]}^{\frac{1}{2}} + {[ 1 - \frac{Nx φ ( x )}{{N}_{L}} - {( \frac{N φ ( x )}{{N}_{L}} )}^{2} ]}^{\frac{1}{2}} \} σ$$

If the added width of L and R is larger than the width of the merged cluster (to be determined as shown below), then L and R should be merged.

In that regard, the merged deviation, σ, increases if the L and R clusters are actually separate. Therefore, a cluster merger based on compactness is tested as one that satisfies the single Gaussian model:

$${σ}_{L} + {σ}_{R} = {\geq }^{merge} \{ {[ 1 + \frac{Nx φ ( x )}{{N}_{R}} - {( \frac{N φ ( x )}{{N}_{R}} )}^{2} ]}^{\frac{1}{2}} + {[ 1 - \frac{Nx φ ( x )}{{N}_{L}} - {( \frac{N φ ( x )}{{N}_{L}} )}^{2} ]}^{\frac{1}{2}} \} σ \qquad ( 5 )$$

However, in in a d-dimensional space, it is often not convenient to measure the deviation in the direction orthogonal to the separating hyper-plane. Therefore, instead, the average deviation in all dimensions of the L and R clusters is measured, as \hat{σ}_{L} and \hat{σ}_{R} respectively. The mean deviations are assumed to be \hat{σ} in d−1 dimensions and \hat{σ}_{L} or \hat{σ}_{R} in one dimension, where \hat{σ}_{R} is the average deviation in all dimensions of the merged cluster. Thus:

$${\hat{σ}}_{L} + {\hat{σ}}_{R} = 2 \frac{d - 1}{d} \hat{σ} + \frac{1}{d} {σ}_{L} + \frac{1}{d} {σ}_{R} {\geq }^{merge} \{ 2 \frac{d - 1}{d} + {\frac{1}{d} [ 1 + \frac{Nx φ ( x )}{{N}_{L}} - {( \frac{N φ ( x )}{{N}_{L}} )}^{2} ]}^{\frac{1}{2}} + {\frac{1}{d} [ 1 - \frac{Nx φ ( x )}{{N}_{L}} - {( \frac{N φ ( x )}{{N}_{L}} )}^{2} ]}^{\frac{1}{2}} \} \hat{σ} \qquad ( 6 )$$

Accordingly, the cluster compactness is evaluated based at least on an average standard deviation in all dimensions of one or more object features in a cluster. The above leads to the compactness merge threshold, which is:

$$\frac{{\hat{σ}}_{L} + {\hat{σ}}_{R}}{\hat{σ}} {\geq }^{merge} 2 \frac{d - 1}{d} + \frac{1}{d} f ( \frac{{N}_{L}}{N} ) \qquad ( 7 )$$

Thus, the right side of the above equation is the threshold which can be used to determine whether to merge the clusters L and R. The compactness threshold is based on a number of objects in the first cluster, the number of objects overall, and the number of dimensions of the object features. In the compactness merge threshold above, noting that

$${N}_{R} = N - {N}_{L} , \\ and$$

$$x = {Φ}^{- 1} ( \frac{{N}_{L}}{N} )$$

$$f ( \frac{{N}_{L}}{N} ) = {[ 1 + \frac{Nx φ ( x )}{{N}_{R}} - {( \frac{N φ ( x )}{{N}_{R}} )}^{2} ]}^{1 / 2} + {[ 1 - \frac{Nx φ ( x )}{{N}_{L}} - {( \frac{N φ ( x )}{{N}_{L}} )}^{2} ]}^{1 / 2} \qquad ( 8 )$$

Plotting

$$f ( \frac{{N}_{L}}{N} )$$

yields the compactness threshold curve shown in FIG. 5B. As can be seen from FIG. 5B, the curve is nearly constant, and it may therefore be possible to use a constant value approximation of f of about 1.21 (the value near the middle of the curve), for example. The threshold can then be observed for various dimensionalities d, as shown in FIG. 5C.

From FIG. 5C, it can be seen that as the dimensionality increases, the sum of the L and R cluster mean d-dimensional deviations approach twice the mean d-dimensional deviation of the merged clusters if the merged cluster is drawn from a multivariate Gaussian. If they are not from a multivariate Gaussian, or there is any spread or space between the L and R clusters, then the mean merged cluster d-dimensional deviation will exceed the threshold.

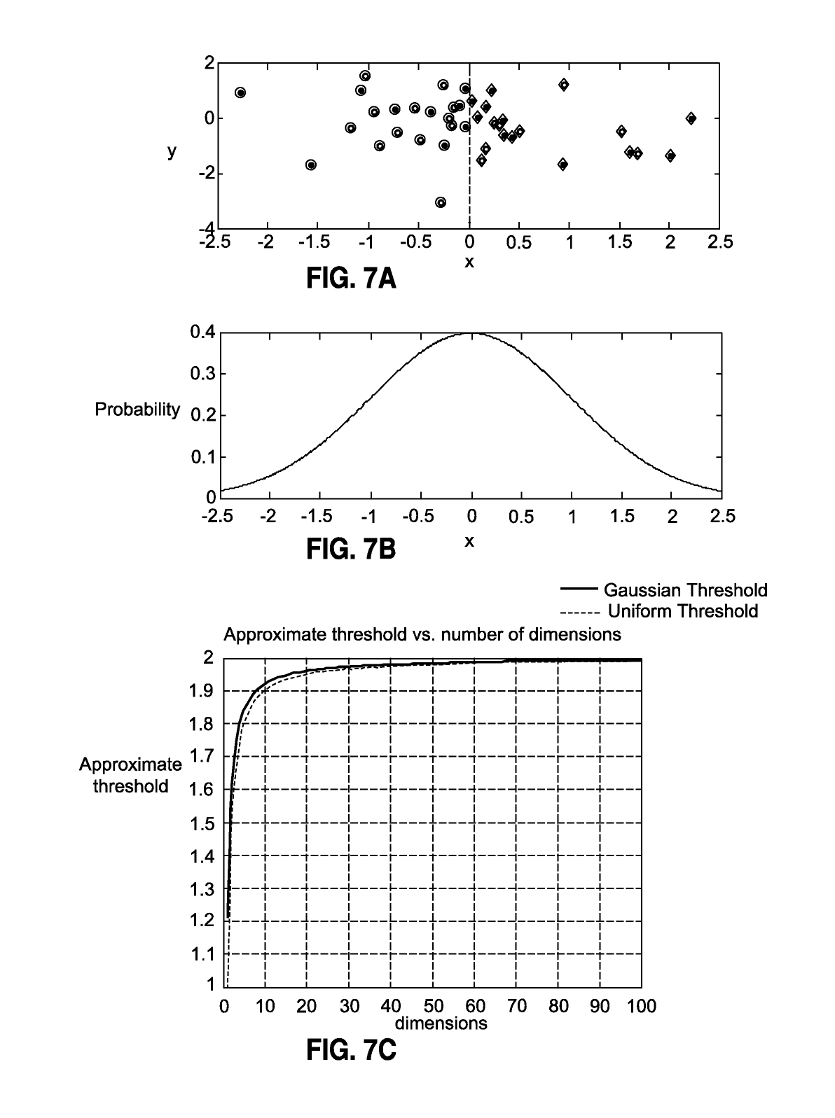

Examples of input data clusters and decisions whether or not to merge the clusters based on cluster compactness, using the threshold defined above, will now be described with respect to FIG. 6A to FIG. 7B.

A first example of input data points is shown in FIG. 6A. Specifically, FIG. 6A shows 20 samples generated from a unit variance Gaussian distribution centered at (0,0) and 20 samples from a unit variance Gaussian distribution centered at (4,0). The samples are separated into a left and right region by a dividing line at x=2. Points on the left are shown with circles, and points on the right are shown with diamonds. The generating distributions are shown in FIG. 6B.

The samples on the left side of the plot in FIGS. 6A and 6B have a sample standard deviation of 1.32 and 0.81 in the x and y directions, respectively. The samples on the right side of FIGS. 6A and 6B have a sample standard deviation of 0.91 and 0.95 in the x and y directions, respectively. Meanwhile, all of the samples have a sample standard deviation of 2.30 and 0.86 in the x and y directions, respectively. The mean sample deviations are 1.07, 0.93, and 1.58 for the left, right and merged samples, respectively. Plugging these numbers into the compactness merge threshold defined above, this gives

$$\frac{{\hat{σ}}_{L} + {\hat{σ}}_{R}}{\hat{σ}} = 1.26 \qquad ( 9 )$$

The value 1.26 is less than the recommended merge threshold of about 1.61 from

$$2 \frac{d - 1}{d} + \frac{1}{d} f ( \frac{{N}_{L}}{N} )$$

as defined above. Accordingly, a merger of these clusters would not be recommended.

Referring back to FIGS. 6A and 6B, the more spread out the data points are, σ_{L} and σ_{R} might not change, but the σ of the merged cluster would increase. Put another way, the cluster compactness is evaluated based at least on the spread of a cluster.

Meanwhile, a second example of input data points is shown in FIG. 6C. FIG. 6C shows 20 samples generated from a unit variance Gaussian distribution centered at (0,0) and 20 samples from a unit variance Gaussian distribution centered at (2,0). The samples are separated into a left and right region by a dividing line at x=1. Points on the left are shown with circles and points on the right are shown with diamonds. The generating distributions in the x-dimension are shown in FIG. 6D.

The samples on the left side of FIG. 6C have a sample standard deviation of 0.89 and 1.33 in the x and y directions, respectively. The samples on the right side of the FIG. 6C have a sample standard deviation of 0.87 and 0.99 in the x and y directions respectively. All of the samples have a sample standard deviation of 1.47 and 1.14 in the x and y directions, respectively. The mean sample deviations are 1.11, 0.93, and 1.35 for the left, right and merged samples, respectively. Plugging in these values gives

$$\frac{{\hat{σ}}_{L} + {\hat{σ}}_{R}}{\hat{σ}} = 1.57 \qquad ( 10 )$$

In this case, 1.57 is also less than the recommended merge threshold of about 1.61 (from

$$2 \frac{d - 1}{d} + \frac{1}{d} f ( \frac{{N}_{L}}{N} )$$

as defined above). Accordingly, a merger of these clusters would also not be recommended.

A third example is shown in FIGS. 7A and 7B. In this example, the data points from the left and right are drawn from a distribution with the same parameters. In this case, when the data is drawn from a distribution with the same parameters, the data yields

$$\frac{{\hat{σ}}_{L} + {\hat{σ}}_{R}}{\hat{σ}} = 1.67 \qquad ( 11 )$$

Thus, in this case, 1.67 exceeds the merger threshold of about 1.61, suggesting that a merger of the left and right clusters is acceptable.

Generally, when the data is drawn from the same distribution as in the example above, the ratio of deviations above may fall close to the threshold value. In some cases, due to random variations the ratio may not exceed the theoretical threshold. Thus, in some embodiments, the threshold may be modified to allow more or fewer mergers. In other embodiments the change in the threshold may depend on the number of samples observed, since larger sample sizes should result in less statistic estimate variance and therefore, the statistics may be trusted as being more likely to be accurate.

In the above examples described with respect to FIG. 6A to FIG. 7B, there is an assumption of an underlying multivariate Gaussian distribution. However, if data is over-clustered even under this assumption, the sub-clusters may be approximately uniform in many cases, because often the data points in the tails belong to another cluster. In such a case, the L and R clusters in the direction orthogonal to the separating hyper-plane have a deviation sum equal to the deviation of the merged cluster in that direction:

σ_{L}+σ_{R}=σ (12)

This leads to a practical threshold of:

$${\hat{σ}}_{L} + {\hat{σ}}_{R} = 2 \frac{d - 1}{d} \hat{σ} + \frac{1}{d} {σ}_{L} + \frac{1}{d} {σ}_{R} {\geq }^{merge} \{ 2 \frac{d - 1}{d} + \frac{1}{d} \} σ \frac{{\hat{σ}}_{L} + {\hat{σ}}_{R}}{\hat{σ}} {\geq }^{merge} \frac{2 d - 1}{d} \qquad ( 13 )$$

Accordingly, in the uniform case, the threshold is constant for a fixed number of dimensions, and does not depend on the number of elements in the L and R clusters. As shown in FIG. 7C, it can be seen that the uniform assumption makes very little difference in the threshold, especially for large dimensionality. Thus, generally, it is often safe to use the same threshold regardless of how σ_{L} and σ_{R} are originally distributed, i.e., that the distribution may not affect the compactness threshold much.

Returning now to FIG. 4, in step 405, the second evaluation which is used to determine whether to merge two clusters is a cluster quality measure. In particular, cluster mergers should also make sense based on ground truth data (i.e., semantic information) available for the clusters to be merged. The semantic information generally describes one or more objects (or other data of the cluster), and, in some cases, semantic information of one or more objects in two or more clusters (e.g., a first cluster and a second cluster) are related. For example, semantic information might include a label “dog” for an image which corresponds in some ways to a dog.

In that regard, while the above compactness criteria is important for determining acceptable cluster mergers from an unsupervised perspective, the cluster quality criteria determines the acceptability of mergers from a supervised perspective. Both of these perspectives are important. Without the compactness criteria, clusters of similar truth composition may be merged even though they are disjoint. On the other hand, without the cluster quality criteria, clusters that are close together may be merged despite their different compositions of truth labels. Both are indicators for whether the data are drawn from the same or different distributions in both space and labels.

Thus, both the compactness measure and the cluster quality measure are used. Generally, the compactness measure is faster to compute and is therefore performed first to weed out candidates, so that the slower cluster quality measure can be performed on fewer candidates. Moreover, using both measures can allow for a more appropriate stopping point for merging, and specifically to mirror a more desired breadth of visual vocabulary as described above.

Turning now to step 405, evaluation of a cluster quality of a candidate cluster based on semantic information (e.g., a “ground truth” or “label”) will now be described.

For example, the system may be presented with a clustering of C clusters, and in step 405, evaluate whether merging two clusters together would improve the clustering quality or not. In general, having fewer clusters to describe a data set is preferable over having more clusters, but joining clusters of different classes of objects is not desirable because the cluster becomes less specific. A Rand Index or adjusted Rand Index measure could be used, for example, to test the clustering quality before and after the merger of two clusters to decide whether the merger provides a better clustering. However, it can be easier to look at the difference of the two measures as there are many common components shared between the two measures. Thus, it is useful to determine when to merge or not merge clusters based on the similarity or dissimilarity of cluster content, and which of the mergable clusters would provide the best merger choice.

A contingency table is used to summarize the clustering of labeled objects into multiple clusters. The table M is a matrix with the i-th row and j-th column element labeled nᵢⱼ. nᵢⱼ is the count of the number of objects with label i that are in cluster j.

If cluster j and cluster k were to be merged into a single cluster, the two columns of the contingency table could be combined by summing them and putting them into a new column while removing columns j and k. Letting α* be the new column vector, it can be seen that α*=αⱼ+αₖ, where αⱼ is the unmerged j-th column.

The unmerged Relational Rand Index is given as RRI₀:

$$R R {I}_{0} = \frac{{( N )}_{2} - {a}^{T} Sa - {b}^{T} b + 2 {\sum }_{c = 1}^{C} {α}_{c}^{T} {Sα}_{c}}{{( N )}_{2}} \qquad ( 14 )$$

In the above equation, a is the row sum vector (the number of objects with each label) with elements given by, αᵢ=Σⱼ₌₁^{C}nᵢⱼ, b is the column sum vector (the number of objects in each cluster) with elements given by bⱼ=Σᵢ₌₁^{R}nᵢⱼ, and N is the total number of objects. Details of calculating the unmerged Relational Rand Index are provided in U.S. application Ser. No. 13/542,433, entitled “Systems and methods for cluster analysis with relational truth” and in PCT/US2011/056441, entitled “Systems and methods for cluster validation”, the contents of which are incorporated by reference herein.

In order to determine whether to merge, it is useful to know the RRI when clusters j and k are merged. First, the term b^{T}b is examined. Deleting the j and k-th columns and adding the merged column yields

$${b}^{T} b {}^{merge j \& k} {( {b}_{j} + {b}_{k} )}^{2} + {\sum }_{c = 1 \\ c \neq j \\ c \neq k}^{C} {b}_{c}^{2} = 2 {b}_{j} {b}_{k} + {\sum }_{c = 1}^{C} {b}_{c}^{2} = 2 {b}_{j} {b}_{k} + {b}^{T} b . \qquad ( 15 )$$

Next, the term Σ_{C=1}^{C}α_{C}^{T}Sα_{C} is examined under the merger:

$${\sum }_{c = 1}^{C} {α}_{c}^{T} {Sα}_{c} {}^{merge j \& k} {( {α}_{j} + {α}_{k} )}^{T} S ( {α}_{j} + {α}_{k} ) + {\sum }_{c = 1 \\ c \neq j \\ c \neq k}^{C} {α}_{c}^{T} {Sα}_{c} = {α}_{j}^{T} {Sα}_{j} + {α}_{j}^{T} {Sα}_{k} + {α}_{k}^{T} {Sα}_{j} + {α}_{k}^{T} {Sα}_{k} + {\sum }_{c = 1 \\ c \neq j \\ c \neq k}^{C} {α}_{c}^{T} {Sα}_{c} = 2 {α}_{j}^{T} {Sα}_{k} + {\sum }_{c = 1}^{C} {α}_{c}^{T} {Sα}_{c} \qquad ( 16 )$$

The last step above is due to the fact that S is (typically) a symmetric matrix.

The other terms in the RRI expression are not changed under the merger. Thus, the difference in the RRI based on the merger can be evaluated as follows:

$$R R {I}_{merged} - R R {I}_{0} = \frac{4 {α}_{j}^{T} {Sα}_{k} - 2 {b}_{j} {b}_{k}}{{( N )}_{2}} \qquad ( 17 )$$

In order to evaluate the cluster quality, the merger Quality Improvement, Δⱼₖ, can be defined by removing the constant terms above:

$${Δ}_{jk} = ( \begin{matrix}N \\ 2\end{matrix} ) ( R R {I}_{merged} - R R {I}_{0} ) = 2 {α}_{j}^{T} {Sα}_{k} - {b}_{j} {b}_{k} \qquad ( 18 )$$

This change can be compared to the expected value of the change to determine whether a merger improves clustering quality more than any change in quality that would occur at random. Thus, attention can now be turned to the expectation of Δⱼₖ.

The expectation of the quality improvement can be generated in multiple ways. One Adjusted Rand Index approach is to assume that the row sums (the class label distribution) are fixed while the cluster sizes are random, as described in PCT Application No. PCT/US2011/56441 (cited above). In this case the expectation is taken over random M and random b. This approach is also repeated for the Adjusted Relational Rand Index in one embodiment of the disclosure.

For example, for a fixed a and a random b, the expected RRI improvement (namely [symbol] [Δⱼₖ|α, C]) can be calculated by reducing the number of clusters and use this value γ as a threshold on Δⱼₖ:

$$γ = ( \begin{matrix}N \\ 2\end{matrix} ) ( 𝔼 [ R R {I}_{merged} \vert a , C - 1 ] - 𝔼 [ R R {I}_{0} \vert a , C ] ) \qquad ( 19 )$$

This approach has the advantage that these expectations do not depend on the clustering results, and therefore remain the same for all possible pairs of mergers from C clusters. Thus the expectation of the RRI needs to only be calculated for C and C-1. The details for calculating these expectations are given in U.S. application Ser. No. 13/542,433 and in PCT/US2011/056441 mentioned above.

An alternative embodiment uses the b values (the sizes of the clusters) in the calculation.

$$γ = ( \begin{matrix}N \\ 2\end{matrix} ) ( 𝔼 [ R R {I}_{merged} \vert a , b , C - 1 ] - 𝔼 [ R R {I}_{0} \vert a , b , C ] ) \qquad ( 20 )$$

Details of calculations under this alternative embodiment are also described in U.S. application Ser. No. 13/542,433 and in PCT/US2011/056441 mentioned above. Thus, in various embodiments, the cluster quality threshold can be calculated using, for example, an expected Rand Index, an Expected Relational Rand Index, or an Expected Mutual Information Measure.

By using the value γ as a threshold on Δⱼₖ (expected improvement in quality), it is possible to determine whether to merge two clusters.

Returning again to FIG. 4, in step 406, the determination is made whether to merge the two clusters or not. As discussed above, both compactness and quality criteria are used to decide when to merge clusters. If the determination is not to merge the clusters, the process proceeds to step 407, where it is determined whether there are additional candidate clusters to merge.

In particular, the process of determining whether to merge clusters may be repeatedly applied to a set of candidate cluster pairs to be merged. In some embodiments this process is repeated until there are no remaining candidate pairs to be merged or until all of candidate pairs have been determined to be not suitable for merging.

In more detail, FIG. 4B depicts an example process for repeatedly applying the process of determining whether to merge clusters to a set of candidate cluster pairs. In particular, in step 451, a list of candidate clusters is input. In step 452, a pair of candidate clusters is selected to be evaluated for merger. In step 453, there is an evaluation of whether to merge the candidate clusters, as described above. In step 454, there is a determination of whether the list of candidate clusters has been exhausted. If the list is not exhausted, the process returns to step 452 to select a new pair of candidate clusters to evaluate, whereas if the list is exhausted, the process ends in step 455.

In that regard, additional information or factors may be used to rank clusters to be examined for merger. For example, a ranking could consider inter-cluster distance (the distance between the two clusters which are being considered for merger). Thus, in this case, first and second clusters are selected as candidates to merge from a plurality of clusters, based in part on a distance between the first and second clusters. A selection of clusters to merge might also consider cluster spread (the distance between the sub-clusters divided by the sum of the average sub-cluster deviations) deviations). Accordingly, in such an embodiment, the first and second clusters are selected as candidates to merge from a plurality of clusters, based on a distance between the first and second clusters relative to the sum of the average standard deviations of object features in the first and second clusters. In still another example, a selection of clusters to merge might consider a modified cluster spread (the distance between the sub-clusters clusters divided by the sum of the average merged cluster deviations). Put another way, in that embodiment, the first and second clusters are selected as candidates to merge from a plurality of clusters, based on a distance between the first and second clusters relative to the sum of the average standard deviations of object features in the candidate cluster. It should be understood that various other combinations of evaluations could be used in a determination.

In general, the ranking function could take a plurality of rank factors and threshold scores and combine them in a way that the order of the cluster mergers can provide the best increase in knowledge representation and retention as measured by any number of measures such as Adjusted RRI (Relational Rand Index), Adjusted RI (Rand Index), and Adjusted Mutual Information, as just a few examples.

Returning again to FIG. 4A, if the determination in step 406 is to merge the clusters, the clusters are merged in step 408, and the process proceeds to step 409.

In step 409, a display of the merged clusters is output (e.g., on display screen 42). For example, a representative image of a merged cluster of images could be selected as a representative image of the cluster for display. In step 410, the process ends.

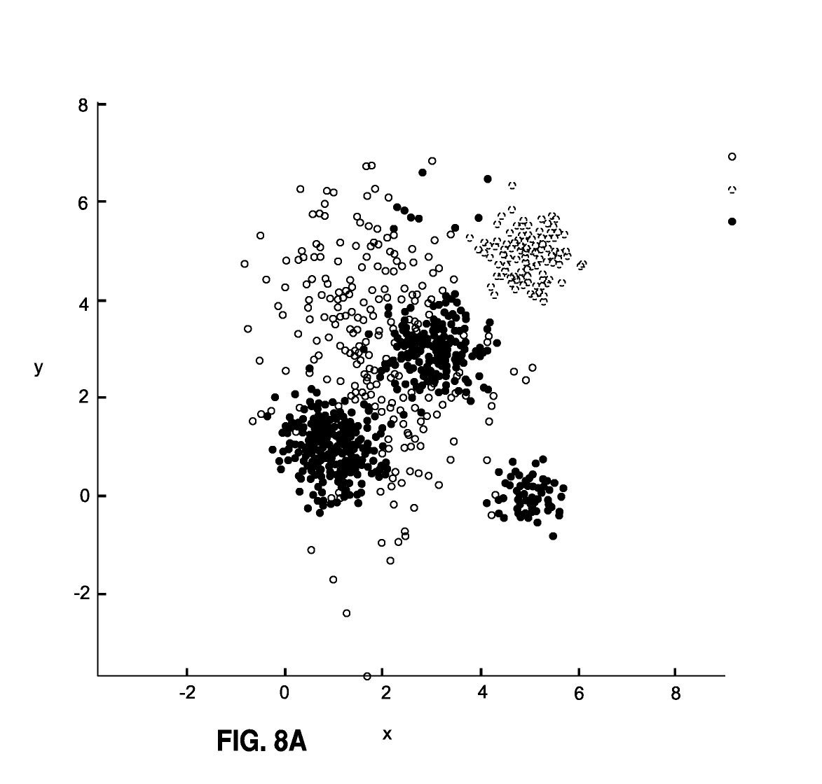

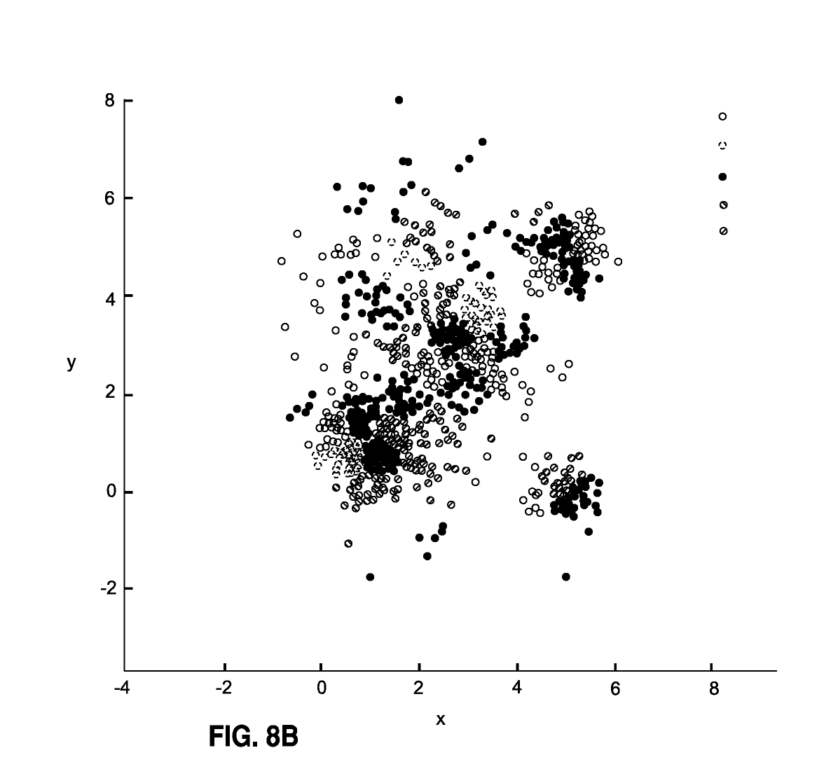

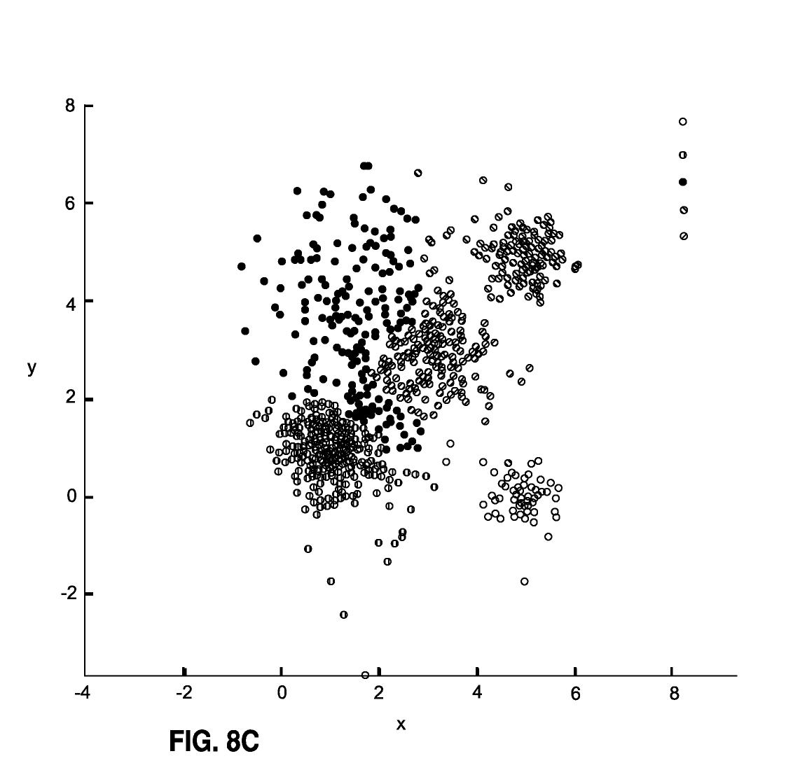

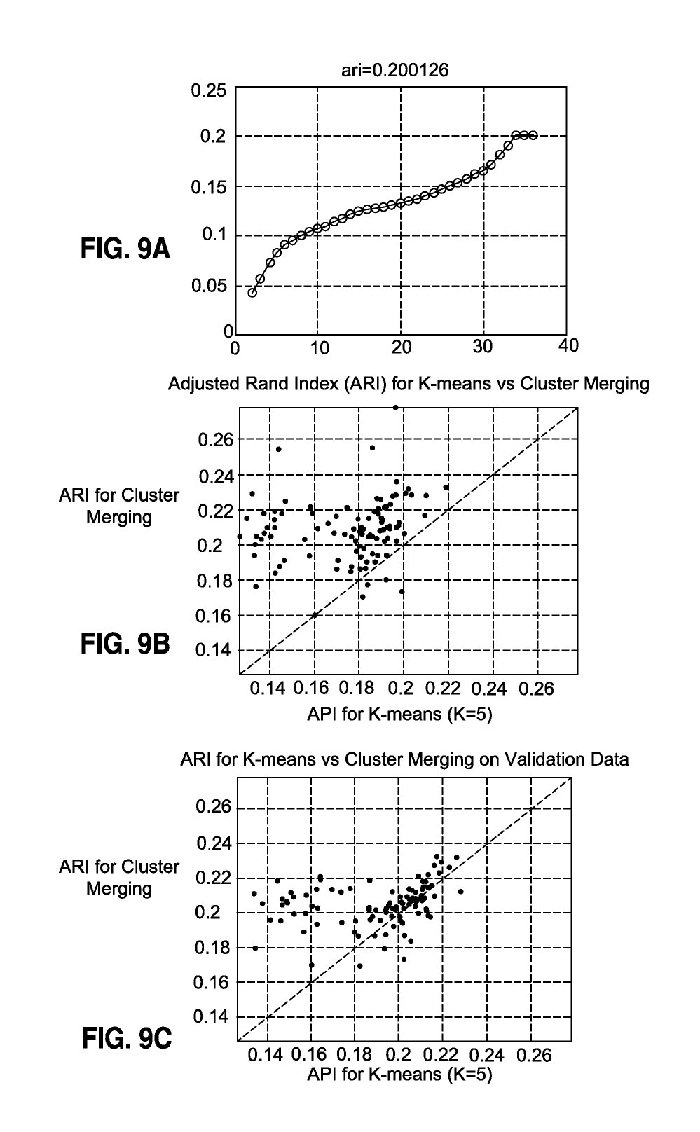

Further examples of the cluster merger method will now be described with respect to FIGS. 8A to 9C.

In particular, FIGS. 8A to 8C depict a data model according to the disclosure that improves understanding of the data as compared to the results obtained from unsupervised clustering.

Specifically, FIG. 8A depicts random data generated from 5 clusters with overlap labeled with 4 independent labels. As shown, the random data is not very compact, and there is significant undesired overlap between the clusters (a frequent problem with most clustering methods). Initially, as shown in FIG. 8B, data is clustered in an unsupervised manner with many clusters (approximately 40 clusters clustered by K-means clustering, in this example). On the other hand, through a series of cluster mergers satisfying the compactness and cluster quality criteria, the many clusters are merged together until there are no more cluster pairs that satisfy the criteria, leading to about 5 clusters, as shown in FIG. 8C.

Meanwhile, FIG. 9A shows that, from the series of mergers, the ARI of the new result increases, indicating improving cluster quality in the sense that there is an improvement in the representation of the ground truth.

Turning to FIG. 9B, in one experiment, the example described above with respect to FIGS. 8A to 8C was repeated 100 times. Each time the data was generated randomly using the same underlying distributions. Clusters were formed using the iterative cluster merger approach shown above and the Adjusted Rand Index was recorded. The same 100 data sets were also clustered using K-means clustering with K=5 clusters. The Adjusted Rand Index was also measured for the K-means clustering. The clustering quality of the 100 experiments (ARI) is plotted below in FIG. 9B. The plot indicates that the cluster merge approach described in this disclosure typically produced higher quality clusters than the unsupervised K-means approach on the training data. Specifically, the cluster merging produced a better ARI score 96 out of 100 cases.

Turning to FIG. 9C, in this experiment, the clusters are validated based on the ARI for an independently generated set of data. This experiment shows that the cluster merging approach does not over-fit the training data and still generally outperforms the K-means approach. These experiments compare to K-means results obtained using K=5. It is important to note that the cluster merging approach does not specify the number of final clusters. Instead the approach uses the aforementioned criteria to determine when there are no more clusters to be merged. On the other hand, typically with K-means it can be difficult to determine the proper number of clusters. Five clusters were used for comparison because K=5 would arguably generate the best possible results for K-means. However, in practice, the number of appropriate K would not be known a priori.

By determining whether to merge clusters of objects based on both a cluster compactness measure and a cluster quality measure, it is ordinarily possible to create a visual vocabulary with an appropriate number of clusters. For example, it is ordinarily possible to create a visual vocabulary which generalizes when necessary (i.e. when there is insufficient data to be more specific or too much noise or variation to be more specific), but also has a sufficient number of visual words to describe different visual features.

An alternative embodiment might instead consider whether to split a single cluster into two clusters, using the same compactness and quality measures, and based on how the split clusters would look. In such an embodiment, the system or a user could determine the hyper-plane (e.g., by a user interface) using a known clustering technique, and essentially use the above processes in reverse.

Thus, according to such an alternative embodiment, an existing cluster of objects is split into a plurality of clusters. Semantic information of at least one of the objects in the existing cluster is input. A respective compactness is evaluated of each of a first candidate cluster and a second candidate cluster to be formed when the existing cluster is split. A respective cluster quality is evaluated of each of the first candidate cluster and the second candidate cluster, based on the semantic information. The existing cluster is split in a case that the respective compactness of the first candidate cluster and the second candidate cluster relative to the compactness of the existing cluster each exceed a compactness threshold, or the respective cluster quality of the first candidate cluster and the second candidate cluster relative to a cluster quality of the existing cluster each exceed a cluster quality threshold.

In other embodiments, the compactness threshold for cluster splitting is weighted more leniently. In other words, if the splitting of the cluster, as determined by some known clustering technique for example, has been recommended, the change in the cluster quality can be considered as a more important criterion than compactness. Thus, compact clusters may be allowed to be split when doing so results in improved cluster quality.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for determining whether to merge clusters of objects, the method comprising:
inputting semantic information of at least one of the objects;
evaluating a compactness of a candidate cluster to be formed when a first cluster and a second cluster are merged;
evaluating a cluster quality of the candidate cluster, based on the semantic information;
merging the first cluster and the second cluster in a case that the compactness of the candidate cluster relative to a compactness of the first and second clusters exceeds a compactness threshold, and the cluster quality of the candidate cluster relative to a cluster quality of the first and second clusters exceeds a cluster quality threshold.

2. The method according to claim 1, wherein the compactness threshold is based on a number of objects in the first cluster, the number of objects overall, and the number of dimensions of an object features.

3. The method according to claim 1, wherein at least two or more semantic information of one or more objects in the first cluster and the second cluster are related.

4. The method according to claim 1, wherein the semantic information describes one or more semantic labels of an image.

5. The method according to claim 1, wherein the cluster compactness is evaluated based at least on an average standard deviation in all dimensions of one or more object features in a cluster.

6. The method according to claim 1, wherein the cluster compactness is evaluated based at least on a standard deviation in a direction of a line connecting the center of the first cluster and the center of the second cluster in a vector space defined by the first cluster and the second cluster.

7. The method according to claim 1, wherein the cluster compactness is evaluated based at least on a spread of a cluster.

8. The method according to claim 1, wherein the cluster quality is based on a Rand Index.

9. The method according to claim 1, wherein the cluster quality is based on a Relational Rand Index.

10. The method according to claim 1, wherein the cluster quality is based on a Mutual Information measure.

11. The method according to claim 1, wherein the cluster quality threshold is calculated using an Expected Rand Index.

12. The method according to claim 1, wherein the cluster quality threshold is calculated using an Expected Relational Rand Index.

13. The method according to claim 1, wherein the cluster quality threshold is calculated using an Expected Mutual Information measure.

14. The method according to claim 1, wherein the first and second clusters are selected as candidates to merge from a plurality of clusters, based in part on a distance between the first and second clusters.

15. The method according to claim 1, wherein the first and second clusters are selected as candidates to merge from a plurality of clusters, based on a distance between the first and second clusters relative to the sum of the average standard deviations of object features in the first and second clusters.

16. The method according to claim 1, wherein the first and second clusters are selected as candidates to merge from a plurality of clusters, based on a distance between the first and second clusters relative to the sum of the average standard deviations of object features in the candidate cluster.

17. An apparatus for organizing a plurality of objects, comprising:
a computer-readable memory constructed to store computer-executable process steps; and
a processor constructed to execute the process steps stored in the memory,
wherein the process steps cause the processor to:
input semantic information of at least one of the objects;
evaluate a compactness of a candidate cluster to be formed when a first cluster of objects and a second cluster of objects are merged;
evaluate a cluster quality of the candidate cluster, based on the semantic information; and
merge the first cluster and the second cluster in a case that the compactness of the candidate cluster relative to a compactness of the first and second clusters exceeds a compactness threshold, and the cluster quality of the candidate cluster relative to a cluster quality of the first and second clusters exceeds a cluster quality threshold.

18. The apparatus according to claim 17, wherein the process steps further cause the processor to select a representative object for the merged cluster.

19. The apparatus according to claim 18, wherein the process steps further cause the processor to display the representative object.

20. The apparatus according to claim 17, wherein the compactness threshold is based on a number of objects in the first cluster, the number of objects overall, and the number of dimensions of an object features.

21. A method for splitting an existing cluster of objects into a plurality of clusters, the method comprising:
inputting semantic information of at least one of the objects in the existing cluster;
evaluating a respective compactness of each of a first candidate cluster and a second candidate cluster to be formed when the existing cluster is split;
evaluating a respective cluster quality of each of the first candidate cluster and the second candidate cluster, based on the semantic information;
splitting the existing cluster in a case that the respective compactness of the first candidate cluster and the second candidate cluster relative to the compactness of the existing cluster each exceed a compactness threshold, or the respective cluster quality of the first candidate cluster and the second candidate cluster relative to a cluster quality of the existing cluster each exceed a cluster quality threshold.
